(19) United States
(12) Patent Application Publication
(10) Pub. No.: US 2016/0309407 A1
(43) Pub. Date: Oct. 20, 2016

(54) Dynamic Selection of a Technology for Cell Broadcast Reception in Multi-SIM Communication Devices

(71) Applicant: QUALCOMM Incorporated, San Diego, CA (US)

(72) Inventors: Francis Ming-Meng Ngai, Louisville, CO (US); Anand Rajurkar, Hyderabad (IN); Soumen Mitra, Hyderabad (IN)

(21) Appl. No.: 14/832,123

(22) Filed: Aug. 21, 2015

(30) Foreign Application Priority Data
Apr. 16, 2015 (IN) 1574/MUM/2015

(51) Int. Cl. H04W 48/18; H04W 24/10; H04L 12/26; H04B 1/3816

(52) U.S. Cl. CPC H04W 48/18; H04B 1/3816; H04W 24/10; H04L 43/16; H04W 88/06

(57) ABSTRACT

Various embodiments enable cell broadcast reception on a multi-SIM mobile communication device with first and second subscriptions for respective technologies. A multi-SIM device may measure channel conditions for the first and second radio access technologies, determine whether the channel conditions of the first radio access technology are greater than or equal to a threshold for receiving cell broadcasts, determine whether the channel conditions of the second radio access technology are greater than or equal to the threshold when the channel conditions of the first radio access technology are less than the threshold, and designate the second radio access technology to receive cell broadcasts when the channel conditions of the second radio access technology are greater than the threshold and disabling cell broadcast reception on the first radio access technology. A Voice or Data call mode on one technology may require another technology to be designated to receive cell broadcasts.

### RELATED APPLICATIONS

This application claims the benefit of priority to Indian Provisional Patent Application No. 1574/MUM/2015 entitled “Dynamic Selection of a Technology for Cell Broadcast Reception in Multi-SIM Communication Devices” filed Apr. 16, 2015, the entire contents of which are incorporated herein by reference.

### BACKGROUND

Some designs of mobile communication devices—such as smart phones, tablet computers, and laptop computers—contain one or more Subscriber Identity Module (“SIM”) cards that provide users with access to multiple separate mobile telephony networks. Examples of mobile telephony networks include Global System for Mobility (GSM), Long Term Evolution (LTE), Code Division Multiple Access (CDMA), Time Division Synchronous Code Division Multiple Access (TD-SCDMA), CDMA2000, and Wideband CDMA (WCDMA). A mobile communication device that includes one or more SIMs and connects to two or more separate mobile telephony networks using one or more shared radio frequency (RF) resources/radios is termed a multi-SIM communication device. One example is a multi-SIM-multi-standby (MSMS) communication device, which includes two or more SIM cards/subscriptions that are each associated with a separate radio access technology (RAT), and the separate RATs share one RF chain to communicate with two or more separate mobile telephony networks on behalf of each RAT's respective subscription.

In accordance with evolving standards and requirements throughout the world, multi-SIM communication devices may be configured or may be required to be configured to receive Emergency Alerts, Cell Broadcasts for each technology supported by the multi-SIM communication device (e.g., each SIM subscription). Examples of specific Cell Broadcast Service standards are set forth by European Telecommunications Standards Institute (ETSI) and are incorporated into the GSM standard (e.g., 3GPP TS 23.041 for GSM, Universal Mobile Telecommunication System (UMTS), and 3GPP TS 23.401 for LTE). Other worldwide examples of Cell Broadcasts include: EU (European Union) Alert in the European/European Union region; Commercial Mobile Alert Services (CMAS) in the US; Rocket Alert “Meser Ishi” in Israel; and Earthquake and Tsunami Warning System (ETWS) in Japan.

Ensuring the ability for multi-SIM communication devices to reliably receive Cell Broadcasts is important because the Cell Broadcasts provide crucial information such as evacuation information or other emergency information associated with emergency events.

### SUMMARY

Various embodiments include methods and devices for implementing the methods for managing reception of cell broadcasts on a mobile communication device, such as a multi-subscriber interface module (SIM) communication device supporting a first subscription of a first radio access technology and a second subscription of a second radio access technology. Methods according to various embodiments may include measuring a channel condition for each of the first radio access technology and the second radio access technologies during a measurement period, determining whether the measured channel condition of the first radio access technology is greater than or equal to a threshold for receiving cell broadcasts, determining whether the measured channel condition of the second radio access technology is greater than or equal to the threshold for receiving cell broadcasts in response to determining that the measured channel condition of the first radio access technology is less than a the threshold for receiving cell broadcasts, designating the second radio access technology to receive cell broadcasts during an interval T, such as a hysteresis interval, and disabling cell broadcast reception on the first radio access technology during the interval in response to determining that the measured channel condition of the second radio access technology is greater than or equal to the threshold for receiving cell broadcasts.

Some embodiments may further include determining whether the mobile communication device is in a Voice/Data call mode using the second radio access technology. In some embodiments designating the second radio access technology to receive cell broadcasts during an interval and disabling cell broadcast reception on the first radio access technology during the interval may be performed in response to determining that the measured channel condition of the second radio access technology is greater than or equal to the threshold for receiving cell broadcasts and that the mobile communication device is not in a Voice/Data call mode using the second radio access technology.

Some embodiments may further include designating the first radio access technology to receive cell broadcasts during the interval and disabling cell broadcast reception on the second radio access technology during the interval in response to determining that the multi-SIM communication device is in a Voice/Data call mode using the second radio access technology.

Some embodiments may further include designating the first radio access technology to receive cell broadcasts during the interval and disabling cell broadcast reception on the second radio access technology during the interval in response to determining that the mobile communication device is not in a Voice/Data call mode using the second radio access technology. Some embodiments may further include designating the first radio access technology to receive cell broadcasts during the interval and disabling cell broadcast reception on the second radio access technology during the interval in response to determining that the measured channel condition of the first radio access technology is greater than or equal to the threshold for receiving cell broadcasts.

Some embodiments may further include determining whether the mobile communication device is in a Voice/Data call mode using the first radio access technology. In some embodiments, designating the first radio access technology to receive cell broadcasts during an interval and disabling cell broadcast reception on the second radio access technology during the interval may be performed in response to determining that the measured channel condition of the first radio access technology is greater than or equal to the threshold for receiving cell broadcasts and that the mobile communication device is not in a Voice/Data call mode using the first radio access technology. Some embodiments may further include remeasuring channel conditions for the first and second radio access technologies after the interval and redesignating one of the first and second radio access technologies to receive cell broadcasts based on the remeasured channel conditions.

Some embodiments may further include establishing the threshold for receiving cell broadcasts by measuring a signal received on a channel associated with receiving the cell broadcasts. Some embodiments may further include establishing a first threshold for receiving cell broadcasts on the first radio access technology and establishing a second threshold for receiving cell broadcasts on the second radio access technology. In some embodiments determining whether the measured channel condition of the first radio access technology is greater than or equal to a threshold for receiving cell broadcasts may include determining whether the measured channel condition of the first radio access technology is greater than or equal to the first threshold for receiving cell broadcasts, and determining whether the measured channel condition of the second radio access technology is greater than or equal to the threshold for receiving cell broadcasts may include determining whether the measured channel condition of the second radio access technology is greater than or equal to the second threshold for receiving cell broadcasts.

Various embodiments include a multi-SIM communication device configured to receive a first SIM card for a first subscription to a first radio access technology, and a second SIM card for a second subscription to a second radio access technology, and having a shared radio-frequency (RF) chain, a memory, and a processor configured with processor-executable instructions to perform operations of the methods described above. Various embodiments include a multi-SIM communication device having means for performing functions of the methods described above. Various embodiments include a non-transitory processor-readable storage medium on which is stored processor-executable instructions configured cause a processor of a multi-SIM communication device to perform operations of the methods described above.

### BRIEF DESCRIPTION OF THE DRAWINGS

The accompanying drawings, which are incorporated herein and constitute part of this specification, illustrate exemplary embodiments, and together with the detailed description, serve to explain the features of the disclosed systems and methods.

FIG. 1A is a communication system block diagram illustrating mobile telephony networks suitable for use with various embodiments.

FIG. 1B is a communication system block diagram illustrating mobile telephony networks and Emergency Alert/Cellular Broadcast System networks suitable for use with various embodiments.

FIG. 2A is a component block diagram illustrating a multi-SIM multi-standby communication device according to various embodiments.

FIG. 2B is a component block diagram illustrating a multi-SIM multi-active communication device according to various embodiments.

FIG. 3 is a diagram illustrating a mobile device configured to receive redundant Cell Broadcasts on two active technologies (“Tech_{X}” and “Tech_{Y}”) in accordance with various embodiments.

FIG. 4A is a diagram illustrating a mobile device configured to receive Cell Broadcasts on technology Tech_{X} and blocking a Cell Broadcast when Tech_{X} is in a call mode in accordance with various embodiments.

FIG. 4B is a diagram illustrating a mobile device configured to receive Cell Broadcasts on technology Tech_{X} and missing a Cell Broadcast when technology Tech_{X} is in an active mode during poor channel conditions.

FIG. 5A is a graph illustrating channel conditions over time for both technologies (“Tech_{X}” and “Tech_{Y}”) during measurement intervals and hysteresis intervals according to various embodiments.

FIG. 5B is a graph illustrating measurement and comparison of channel conditions for both technologies (“Tech_{X}” and “Tech_{Y}”) to thresholds during measurement intervals and designation of technologies for reception of Cell Broadcasts during hysteresis intervals in accordance with various embodiments.

FIG. 6A is a process flow diagram illustrating a method for performing operations to configure technologies for Cell Broadcast reception in accordance with various embodiments.

FIG. 6B is a process flow diagram further illustrating a method for performing operations to configure technologies for Cell Broadcast reception during measurement and hysteresis intervals in accordance with various embodiments.

FIG. 6C is a process flow diagram further illustrating a method for performing operations to configure technologies for Cell Broadcast reception during measurement and hysteresis intervals in accordance with various embodiments.

FIG. 7 is a component block diagram of a mobile communication device suitable for implementing various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the written description or the claims.

As used herein, the term “multi-SIM communication device” refers to any one, some or all of devices including cellular telephones, smart phones, personal or mobile multi-media players, personal data assistants, laptop computers, tablet computers, smart books, palm-top computers, wireless electronic mail receivers, multimedia Internet-enabled cellular telephones, wireless gaming controllers, and similar personal electronic devices that includes a capability for two or more SIM cards, a programmable processor, memory, and circuitry for connecting to at least two mobile communication network with one or more shared RF resources. Various embodiments may be useful in mobile communication devices, such as smart phones and such devices are referred to in the descriptions of various embodiments. However, the embodiments may be useful in any electronic devices that may individually maintain a plurality of subscriptions to RATs that utilize at least one shared RF chain, which may include one or more of antennae, radios, transceivers, etc. Multi-SIM communication devices may be configured to operate in “multi-SIM, multi-standby” (MSMS) mode, “multi-SIM multi-active” (MSMA), “dual-SIM dual standby” (DSDS), “dual-SIM, dual-active,” (DSDA), etc.

As used herein, the terms “SIM,” “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a multi-standby communication device on a network and enable a communication service with the network. Because the information stored in a SIM enables the multi-SIM communication device to establish a communication link for a particular communication service with a particular network, the term “subscription” is used herein as a shorthand reference to refer to the communication service associated with and enabled by the information stored in a particular SIM as the SIM and the communication network, as well as the services and subscriptions supported by that network, correlate to one another.

In a multi-SIM communication device, two or more RATs may function on the same device. For example, a dual-SIM device may support both WCDMA and GSM technologies, or both RATs may support WCDMA technology. The dual-SIM mobile communication may be configured as a dual-SIM dual-standby (DSDS) device, meaning that both RATs share one RF resource and only one RAT may be active at any one time, with the other RAT in the idle mode. Generally, a multi-SIM multi-standby (MSMS) communication device has two or more RATs, all of which share one RF resource and only one RAT may be active at any one time, with the other RATs in the idle mode. In multi-SIM multi-active (MSMA) and dual-SIM dual-active (DSDA) communication devices, both RATs may be active at the same time. In the present disclosure, the terms “TechX” and “TechY” are used to refer in general to two different RATs (e.g., WCDMA and GSM), which may be RATs associated with different service providers associated with the SIM subscriptions. Such service providers may use the different RATs or may use different implementations of the same RAT. Various embodiments may not be dependent on the specific type of technology.

If a multi-SIM communication device is configured such that multiple subscriptions (e.g., associated with multiple SIMs) will receive Cell Broadcast information at the same time, a power penalty may be incurred as both technologies need to stay active for Cell Broadcast reception. Voice or data communications performance may also be affected if the corresponding technology is in a connected mode, as the technology has to be suspended while the Cell Broadcast is received. For example, in UMTS and Long Term Evolution (LTE) systems, CMAS reception is allowed in the connected mode. Thus, in a multi-SIM communication device in which Tech_{X}=LTE and Tech_{Y}=UMTS/WCDMA, if both Tech_{X} and Tech_{Y} are receiving the CMAS message, a power and throughput penalty may be observed. Further, if a single technology is designated, associated, or prioritized for Cell Broadcast reception in the multi-SIM communication device, and if that technology does not support Cell Broadcast reception in the connected mode or in voice call (e.g., Cell Broadcast blocked), the multi-SIM communication device may miss the Cell Broadcast alert completely when the multi-SIM communication device is connected or on a call with the designated technology. Alternatively or additionally, if the designated technology is experiencing poor channel condition, then Cell Broadcast or Cell Broadcast update may also be missed.

For example, for GSM/GPRS systems, CMAS reception is not allowed while the multi-SIM communication device is in a voice call or in a connected mode (e.g., data connectivity mode). Hence for a multi-SIM communication device in which Tech_{X}=GSM and Tech_{Y}=any other RAT, the CMAS message through GSM can't be received while in Voice call or in data connectivity. Regardless of the particular technologies, the Cell Broadcast or Cell Broadcast update may be missed if Cell Broadcast reception is designated to a single RAT, say Tech_{X}, and that RAT is in very poor channel condition/OOS.

Cell Broadcast/Cell Information (CI) messaging (also known as Short Message Service-Cell Broadcast (SMS-CB)) is a service that enables simultaneous delivery of important messages to multiple users in a specified area. Cell Broadcast is a one-to-many geographically focused messaging service that is supported by many technologies throughout the world. Cell Broadcast messaging may be used for nation-wide, city-wide, and/or locality-wide alerting, such as providing weather reports, mass messaging, location-based news, emergency alters, and other information. The Cell Broadcast standards define a text or binary message that can be distributed to all mobile terminals connected to a set of cells in a given area. Cell Broadcast messages are generally provided on an unconfirmed push basis. The reception of Cell Broadcast messages may be enabled or disabled. Cell Broadcast services are configured to be impervious to traffic load such that Cell Broadcast messages may be effectively sent and received during disaster situations (e.g., when traffic load peaks are experienced). Thus, Cell Broadcast services may be used to provide disaster or emergency information, organize emergency or disaster relief efforts, warn of further disaster or emergency events, provide evacuation route information or updates, and so on.

A Cell Broadcast may be originated from a Cell Broadcast Centre (CBC), which, depending on the RAT, may be connected to a base station controller (BSC) in GSM networks, and a radio network controller (RNC) in UMTS networks via standardized interfaces, such as using TCP/IP. The Cell Broadcast messages are generally transmitted with a list of destination cells and other information, such as a requested frequency for repetition, the number of times the messages will be transmitted from the originating node, and other information. The Cell Broadcast messages are then transmitted to base stations, NodeBs, etc., which are responsible for handling the cells designated by the originator.

Multi-SIM communication devices may be configured to receive Cell Broadcasts (e.g., EU Alert/CMAS/ETWS) for each technology supported by the multi-SIM communication device (e.g., each SIM subscription). Specifics of Cell Broadcasts are defined by European Telecommunications Standards Institute (ETSI) and are incorporated into the GSM standard. (e.g., 3GPP TS 23.041 for GSM, UMTS, and 3GPP TS 23.401 for LTE). Worldwide examples of Cell Broadcasts include:
EU Alert in European region.
Commercial Mobile Alert Services (CMAS) in US.
Rocket Alert “Meser Ishi” in Israel.
Earthquake and Tsunami Warning System (ETWS) in Japan.

However, Cell Broadcasts may be used for a variety of messaging purposes where messages having geographical significance may be required to be broadcast to devices within certain areas covered by a cell or cells that serve a geographic area.

In overview, various embodiments involve configuring a multi-SIM communication device that has at least two SIM subscriptions, each of which are configured for Cell Broadcast reception, to conserve power while increasing the probability that a Cell Broadcast will be received. Specifically, a multi-SIM communication device may be configured to take link quality measurements for each technology (e.g., Tech_{X} and Tech_{Y}) over a measurement period T_{MEAS}. In some embodiments, if the link quality of Tech_{X} is less than a threshold value “Thresh_{CB}” (e.g., a minimum link quality sufficient to ensure reception of the Cell Broadcast) and the link quality Tech_{Y} is greater than or equal to the Thresh_{CB}, then Tech_{Y} may be designated to receive Cell Broadcast message during an interval “T_{HYST},” after which the process may be repeated.

In various embodiments, the link quality thresholds for Cell Broadcast reception may be the same or different from link quality levels that may be acceptable or sufficient for signal reception on other channels or for other traffic. In other words, the Cell broadcast link quality thresholds may only be relevant to reception of Cell Broadcasts. More specifically, the signal conditions that are sufficient to ensure successful reception of Cell Broadcasts may be different (e.g., lower or higher) than the signal conditions required for the successful reception of other traffic, whether on the same channel or a different channel.

When Tech_{Y} is designated for reception of the Cell Broadcast transmissions, the Cell Broadcast reception on the non-designated technology (Tech_{X}) may be disabled. Receiving Cell Broadcasts on just one technology can reduce power consumption. Selection of that technology may depend on the signal strength of signals received on the technologies. The signal strength of each technology may be compared to a threshold that is common for each of the technologies, or to a technology-specific threshold. The received signal strength in the technology selected to receive Cell Broadcast should be greater than (or equal to) the threshold value, as well as greater than received signal strength of the other technology. Additionally, the technology selected to receive Cell Broadcast should not be in a Voice/Data mode in which Cell Broadcast reception cannot be supported.

Various embodiments provide efficiency benefits. For dual receiver-DSDS/DSDA (or MSMS/MSMA) implementations, during intervals when Tech_{X} is in either an idle mode or an offline mode (e.g., not active), Cell Broadcast reception exclusively on Tech_{Y} saves power in the UE. During intervals when Tech_{X} is in the connected mode for a voice call or data communication session, the active communication session is not affected (e.g., will not be blocked) and modem performance is improved as any Cell Broadcast reception that may be necessary is directed to a single dedicated technology (e.g., Tech_{Y}). Because Tech_{Y} is designated for Cell Broadcast reception, voice/data calls on Tech_{X} may proceed uninterrupted as there is no need to service a Cell Broadcast message on Tech_{X}. During intervals where Tech_{X} is in an idle mode, voice/data mobile terminating (MT) pages can be received without Cell Broadcast interference through Tech_{X}, which improves the overall MT reception performance of the modem.

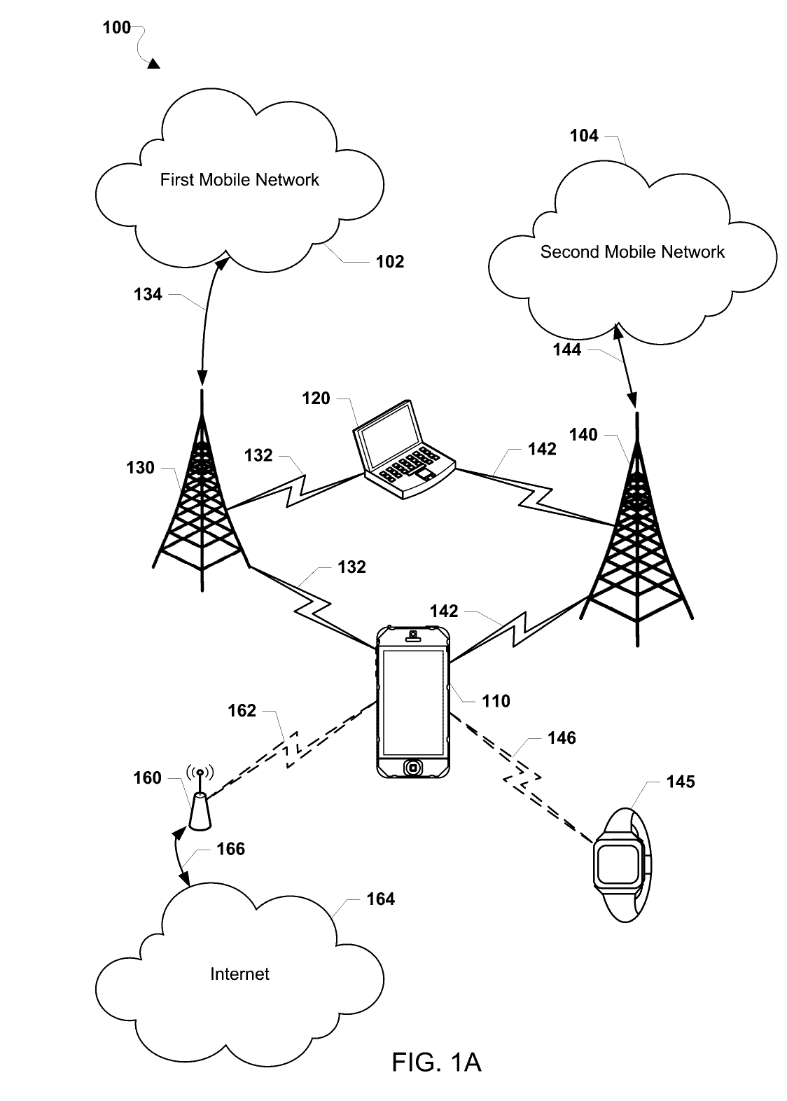

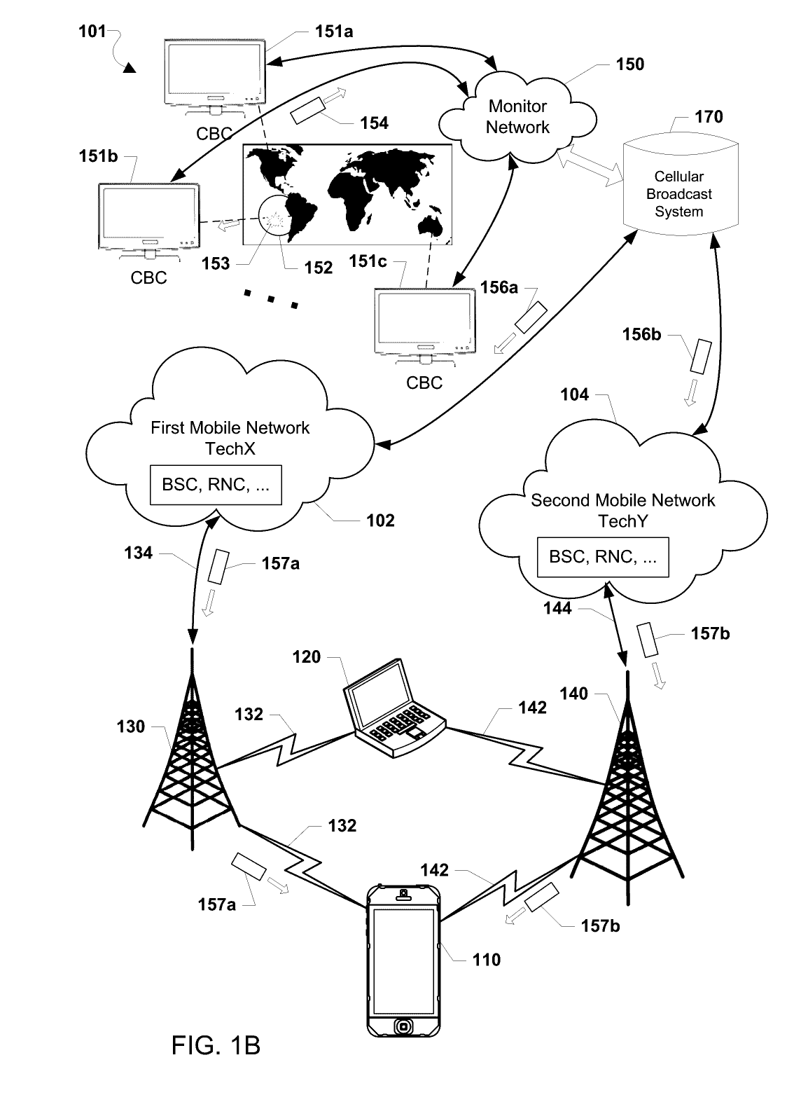

Various embodiments may be implemented within a variety of communication systems 100, such as at least two mobile telephony networks, an example of which is illustrated in FIG. 1A. A first mobile network 102 may include a first base station 130. A second mobile network 104 may include a second base station 140. Typically, the first mobile network 102 and the second mobile network 104 may each include a plurality of base stations. A first multi-SIM communication device 110 may be in communication with the first mobile network 102 through a cellular connection 132, such as to the first base station 130. The first multi-SIM communication device 110 may also be in communication with the second mobile network 104 through a cellular connection 142 to the second base station 140. The first base station 130 may be in communication with the first mobile network 102 over a connection 134, which may be a wired or wireless connection. The second base station 140 may be in communication with the second mobile network 104 over a connection 144, which may be a wired or wireless connection.

In some embodiments, a second multi-SIM communication device 120 may similarly communicate with the first mobile network 102 through the cellular connection 132 to the first base station 130. The second multi-SIM communication device 120 may also communicate with the second mobile network 104 through the cellular connection 142 to the second base station 140. The cellular connections 132 and 142 may be made through two-way wireless communication links established according to various communication technologies, such as 4G, 3G, CDMA, TDMA, WCDMA, GSM, and other mobile telephony communication technologies.

The multi-SIM communication devices 110, 120 may be connected to one or more of the first mobile network 102 and the second mobile network 104. In various embodiments, in order to connect to the first mobile network 102 and the second mobile network 104, the multi-SIM communication devices 110, 120 may include two (or more) SIMs associated with respective subscriptions for the first mobile network 102 and the second mobile network 104.

In some embodiments, the first multi-SIM communication device 110 may optionally establish a wireless connection 146 with a peripheral device 145 used in connection with the first multi-SIM communication device 110. For example, the first multi-SIM communication device 110 may communicate over a Bluetooth® link with a Bluetooth-enabled personal computing device (e.g., a “smart watch”). In some embodiments, the first multi-SIM communication device 110 may optionally establish a wireless connection 162 with a wireless access point 160, such as over a Wi-Fi connection. The wireless access point 160 may be configured to connect to the Internet 164 or another network over a wired connection 166. While not illustrated, the second multi-SIM communication device 120 may similarly be configured to connect with the peripheral device 145, the wireless access point 160 and/or other devices over wireless links or wired links.

In a wireless communication system 101 illustrated in FIG. 1B, the emergency alerts, broadcasts, referred to collectively or interchangeably herein as cell broadcasts or (“Cell Broadcasts”), may be provided through a cell broadcast system or network 150. With reference to FIGS. 1A and 1B, the network 150 may include a series of geographically based terminals, such as terminals 151a, 151b, 151c. One or more of the terminals may be associated with monitoring and providing alert relevant to a geographic area. For example, the terminal 151b may receive information regarding an event 153, which may be an emergency event, a weather event, earthquake event, tsunami event, child abduction emergency (CAE) (e.g., AMBER alert), etc. relevant to a geographical area 152. The terminal 151b may transmit an alert 154 through the network 150 to a cellular broadcast system 170. In some embodiments, the network 150 and the cellular broadcast system 170 may be implemented at least partially using the Internet 164 (see, FIG. 1A). Other portions of the network 150 and/or the cellular broadcast system 170 may be private networks, public/public switched telephone networks, service provider networks, or networks other than or in addition to the Internet 164.

The cellular broadcast system 170 may forward or otherwise transmit a an alert message 156a to the first mobile network 102, which may be configured according to a technology Tech_{X}. The cellular broadcast system 170 may forward or otherwise transmit an alert message 156b to the second mobile network 104, which may be configured according to a technology Tech_{Y}. The first mobile network 102 and the second mobile network 104 may have infrastructure elements such as a base station controller (BSC), radio network controller (RNC), NodeB, eNodeB, etc. with which to receive the alert messages 156a, 156b. For example the infrastructure elements of the respective technologies Tech_{X} and Tech_{Y} may be configured to recognize and process the alert messages 156a, 156b and the information they contain. The alert messages 156a, 156b may contain information such the geographic coverage are for transmitting Cell Broadcast messages, which includes geographic areas within the coverage area of the respective infrastructure element(s) relevant to the Cell Broadcast message.

The alert messages 156a 156b may be received, processed, and forwarded as Cell Broadcasts 157a, 157b to base stations 130, 140, which may transmit the Cell Broadcasts 157a, 157b (respectively) periodically on the cellular connections 132, 142. The first multi-SIM communication device 110 may receive one or more of the Cell Broadcasts 157a, 157b periodically on the cellular connections 132, 142.

In some situations, the alert may have been generated for an area other than the area in which a multi-SIM communication device is located. However, due to the scope of the potential threat, the geographic area in which the multi-SIM communication device is located may nonetheless become subject to the warning. For example, an event may occur in a remote area (e.g., earthquake) that is not immediately relevant to the area in which the multi-SIM communication device is located. However, a resulting tsunami may become relevant to the geographic area of the multi-SIM communication device even though remote from the original earthquake. Thus, the multi-SIM communication device may receive a Cell Broadcast relevant to a tsunami in a second location based on an alert generated for an earthquake in first location that is remote from the second location. In other embodiments, the tsunami-related Cell Broadcast may be generated locally based on separate tsunami warning systems.

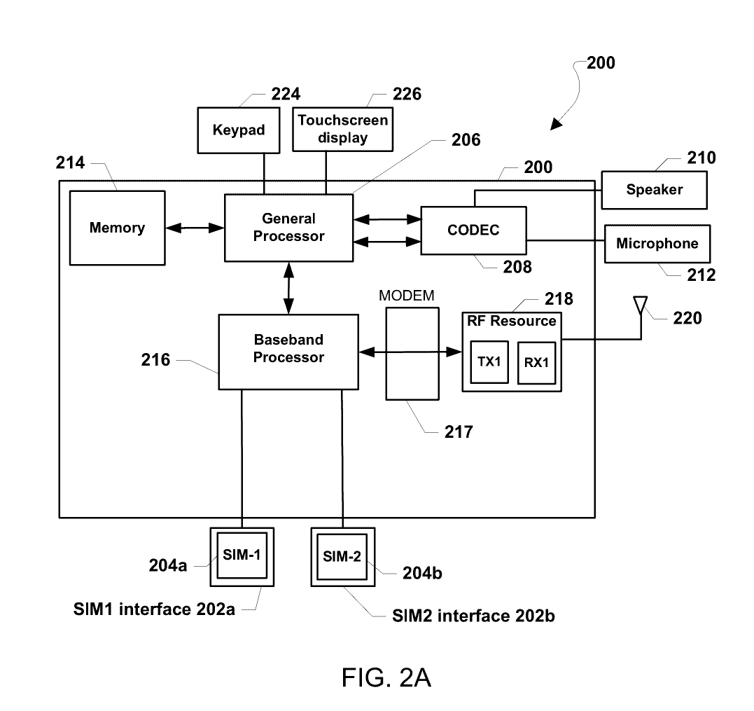

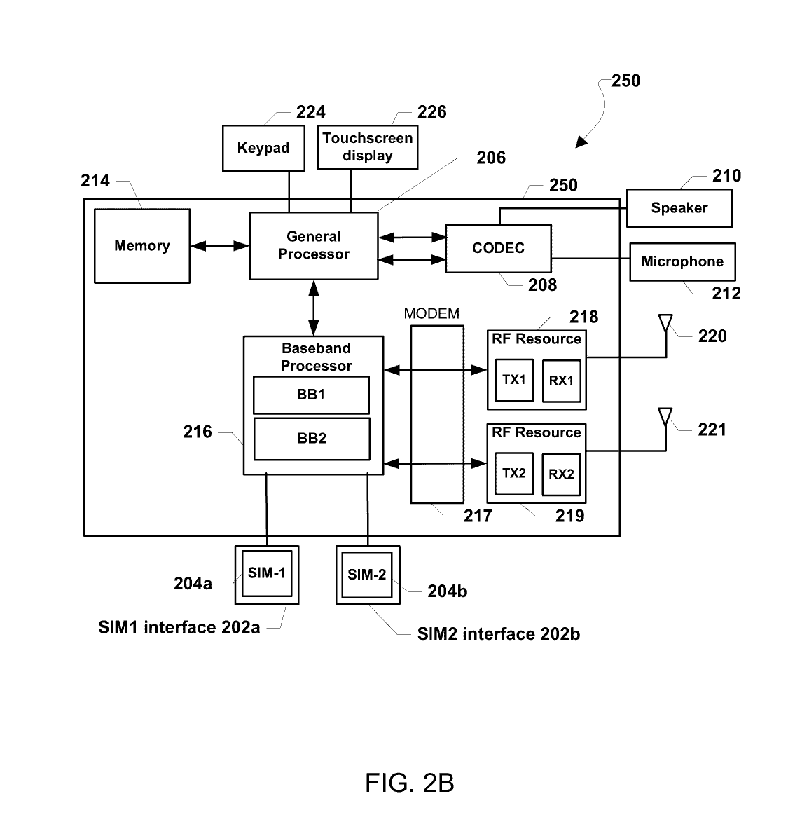

FIGS. 2A and 2B are functional block diagram of multi-SIM communication devices suitable for implementing various embodiments. FIG. 2A illustrates a dual-SIM dual standby (DSDS) device 200 in which a single baseband processor, modem and RF resources may be shared between two (or more) subscriptions. FIG. 2B illustrates a dual-SIM dual active (DSDA) device 250, with a separate baseband processor, modem and RF resources for each of two or more subscriptions. Because DSDS and DSDA devices include similar components and provide similar functionality, differing primarily in the number of RF resources, FIGS. 2A and 2B are described together.

With reference to FIGS. 1A-2B, a multi-SIM communication device 200 may include connections for receiving a first SIM interface 202a, which may receive a first identity module SIM-1 204a that is associated with a first subscription for a service provided using a first radio access technology, such as Tech_{X} as described. The multi-SIM communication device 200, 250 may also include connections for receiving a second SIM interface 202b, which may receive a second identity module SIM-2 204b that is associated with a second subscription for a service provided using a second radio access technology, such as Tech_{Y} as discussed.

A SIM in various embodiments may be a Universal Integrated Circuit Card (UICC) that is configured with SIM and/or universal SIM (USIM) applications, enabling access to, for example, GSM/GPRS, UMTS/WCDMA, and/or LTE networks. The UICC may also provide storage for a contact list and other information and/or applications. Alternatively, in a CDMA network, a SIM may be a UICC removable user identity module (R-UIM) or a CDMA subscriber identity module (CSIM) on a card. A SIM card may have a CPU, ROM, RAM, EEPROM and I/O circuits.

In various embodiments, a SIM may contain user account information, an international mobile subscriber identity (IMSI), a set of SIM application toolkit (SAT) commands, and storage space for phone book contacts. A SIM card may further store home identifiers (e.g., a System Identification Number (SID)/Network Identification Number (NID) pair, a Home PLMN (HPLMN) code, etc.) to indicate the SIM card network operator provider. An Integrated Circuit Card Identity (ICCID) SIM serial number may be printed on the SIM card for identification. However, a SIM may be implemented within a portion of memory of the multi-SIM communication device 200, 250 (e.g., in a memory 214), and thus need not be a separate or removable circuit, chip or card.

The multi-SIM communication device 200, 250 may include at least one controller, such as a processor 206, which may be coupled to a coder/decoder (CODEC) 208. The CODEC 208 may in turn be coupled to a speaker 210 and a microphone 212. The processor 206 may also be coupled to the memory 214. The memory 214 may be a non-transitory computer-readable storage medium that stores processor-executable instructions. For example, the instructions may include routing communication data relating to the first or second subscription though a corresponding baseband-RF resource chain.

The memory 214 may store an operating system (OS), as well as user application software and executable instructions. The memory 214 may also store application data, such as an array data structure. The memory 214 may also store network information obtained by the SIM-1 204a or the SIM-2 204b during an idle mode wakeup. This network information is accessible by both the SIM-1 204a and the SIM-2 204b to use in performing idle mode operations. For example, the memory 214 may include a static random access memory (SRAM) component that stores sample values obtained from the network as part of the network information.

The processor 206 and the memory 214 may each be coupled to at least one baseband modem processor 216, which may couple to or incorporate a baseband modem 217. The baseband modem 217 may encode and decode information to be ultimately transmitted/received over the air. Each SIM and/or RAT in the multi-SIM communication device 200, 250 (e.g., the SIM-1 204a and/or the SIM-2 204b) may be associated with a baseband-RF resource chain. With reference to the DSDA device 250, a baseband-RF resource chain may include the baseband modem processor 216, which may perform baseband/modem functions for communications with/controlling a RAT, and may include one or more amplifiers and radios, referred to generally herein as RF resources (e.g., RF resource 218, 219). In some embodiments, such as the DSDS device 200, the baseband-RF resource chains may share the baseband modem processor 216 (i.e., a single device that performs baseband/modem functions for all RATs on the multi-SIM communication device 200, 250). In some embodiments, such as the DSDA device 250, each baseband-RF resource chain may include physically or logically separate baseband processors (e.g., BB1, BB2). Further, in some embodiments the RF resources 218 and 219 may be separate resources or shared resources.

The RF resource 218 may be a transceiver that performs transmit/receive functions for each of the SIMs/RATs on the multi-SIM communication device 200, 250. The RF resource 218 may include separate transmit and receive circuitry, or may include a transceiver that combines transmitter and receiver functions. In some embodiments, the RF resource 218 may include multiple receive circuitries. The RF resource 218 may be coupled to a wireless antenna (e.g., a wireless antenna 220). The RF resource 218 may also be coupled to the baseband modem processor 216. In multi-SIM multi-active embodiments, such as the DSDA device 250, the multi-SIM communication device 250 may include as second RF resource 219 configured similarly to the RF resource 218 and coupled to a wireless antenna 221.

In some embodiments, the processor 206, the memory 214, the baseband modem processor(s) 216, and the RF resources 218, 219 may be included in the multi-SIM communication device 200, 250 as a system-on-chip 250. In some embodiments, the first and second SIMs 204a, 204b and the corresponding SIM interfaces 202a, 202b to each subscription may be external to the system-on-chip 250. Further, various input and output devices may be coupled to components on the system-on-chip 250, such as interfaces or controllers. Example user input components suitable for use in the multi-SIM communication device 200, 250 may include, but are not limited to, a keypad 224, a touchscreen display 226, and the microphone 212.

In some embodiments, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive selection of a contact from a contact list or to receive a telephone number. As another example, the request to initiate the outgoing call may be in the form of a voice command received via the microphone 212. Interfaces may be provided between the various software modules and functions in the multi-SIM communication device 200, 250 to enable communication between them, as is known in the art.

With reference to the DSDA device 250, functioning together, the SIMs 204a, 204b, the baseband processor BB1, BB2, the RF resources 218, 219, and the wireless antennas 220, 221 may constitute two or more radio access technologies (RATs). For example, the multi-SIM communication device 200, 250 may be a Single Radio LTE (SRLTE) communication device that includes a SIM, baseband processor, and RF resource configured to support two different RATs, such as LTE, Wideband Code-Division Multiple Access (WCDMA), and Global GSM. More RATs may be supported on the multi-SIM communication device 200, 250 by adding more SIM cards, SIM interfaces, RF resources, and antennae for connecting to additional mobile networks.

In some embodiments (not shown), the multi-SIM communication device 200, 250 may include, among other things, additional SIM interfaces for receiving additional SIM cards, a plurality of RF resources associated with the additional SIM cards, and additional antennae for supporting subscriptions communications with additional mobile networks.

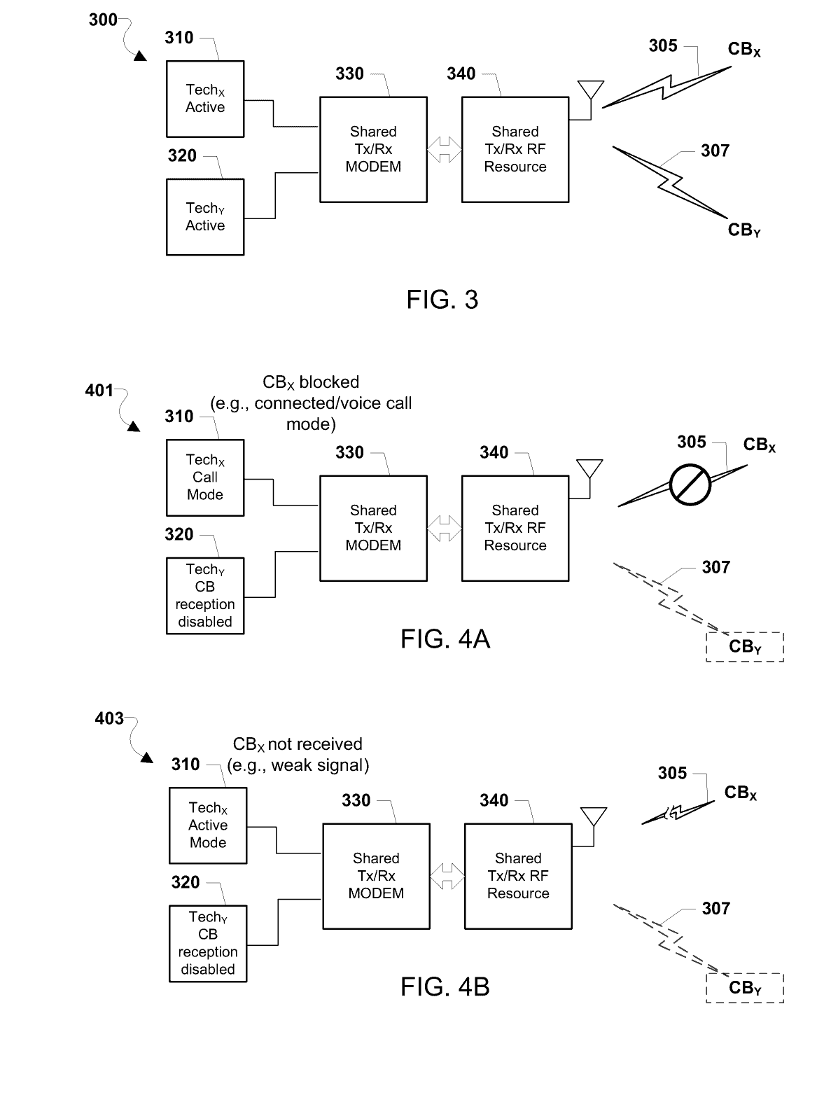

FIG. 3 illustrates a multi-SIM communication device 300 in which the first subscription 310 Tech_{X} and the second subscription 320 Tech_{Y} are both in the active mode (i.e., both subscriptions are actively communicating with a network for voice communication or data transfer). With reference to FIGS. 1A-3, the multi-SIM communication device 300 includes a shared transmit/receive modem 330 for encoding information for transmission and for decoding information received from a shared RF resource 340. The shared RF resource 340 may be configured for transmitting and receiving RF signals. The shared RF resource 340 may transmit encoded signals received from the modem 330 and may receive RF signals from the air interface and transfer the received RF signals to the modem 330 for decoding. Intermediate operations may be performed, such as up conversion operations and down conversion operations between baseband frequencies and transmission band frequencies, which are omitted for ease of description.

The multi-SIM communication device 300 may be configured to receive Cell Broadcasts on both Tech_{X} (also referred to as “CB_{X}”) and Tech_{Y} (also referred to as “CB_{Y}”). Thus, in some instances the multi-SIM communication device 300 may receive a CB_{X} 305 from Tech_{X} and a CB_{Y} 307 from Tech_{Y} at the same or nearly the same time. The CB_{X} 305 and the CB_{Y} 307 may be received in the shared RF resource 340 and processed in the modem 330. As both technologies are active and both RF chains for processing the CB_{X} 305 and the CB_{Y} 307 are active, the reception of the CB_{X} 305 and the CB_{Y} 307 may consume power due to the redundancy. Additionally, if a voice or data call is active for one or more of the subscriptions, the quality of the call may be degraded during the reception of the Cell Broadcast. In the event that a call is active on both subscriptions, power consumption and user experience may be affected.

FIG. 4A illustrates a multi-SIM communication device 401 configured to limit the reception of Cell Broadcasts to one of the at least two subscriptions for two technologies (e.g., Tech_{X} and Tech_{Y}). With reference to FIGS. 1A-4A, in the multi-SIM communication device 401, the first subscription 310 Tech_{X} may be designated for reception of Cell Broadcasts, and the reception of Cell Broadcasts on a second subscription 320 (Tech_{Y}) may be disabled. In many technologies, the reception of Cell Broadcasts may be inhibited in the active mode during a call. Assuming that Tech_{X} does not permit the reception of Cell Broadcasts during a call even when designated for Cell Broadcast reception, the reception of the CB_{X} 305 from Tech_{X} may be blocked or inhibited when the multi-SIM communication device is on a call with Tech_{X}. Because the reception of Cell Broadcasts for Tech_{Y} is inhibited due to the designation of Tech_{X} for Cell Broadcast reception, the Cell Broadcast CB_{Y} 307 from Tech_{Y} will not be received. Thus, the Cell Broadcast will be missed on both technologies.

FIG. 4B illustrates a multi-SIM communication device 403 configured to limit reception of Cell Broadcasts to one of the at least two subscriptions for two technologies (e.g., Tech_{X} and Tech_{Y}) according to various embodiments. With reference to FIGS. 1A-4B, in the multi-SIM communication device 403, the first subscription 310 Tech_{X} may be designated for reception of Cell Broadcasts. The reception of Cell Broadcasts on the second subscription 320 Tech_{Y} may be disabled. FIG. 4B illustrates a scenario in which the channel conditions are such that reception of the Cell Broadcast on Tech_{X} may not possible or may not be reliable. Assuming that Cell Broadcast reception on Tech_{Y} is disabled due to the designation of Tech_{X} for reception of Cell Broadcasts, Tech_{Y} will not permit or support the reception of Cell Broadcasts. As a result, the reception of the CB_{X} 305 from Tech_{X} may not be possible due to poor channel conditions, and the reception of CB_{Y} 307 from Tech_{Y} is not possible because Tech_{Y} is blocked from receiving Cell Broadcasts.

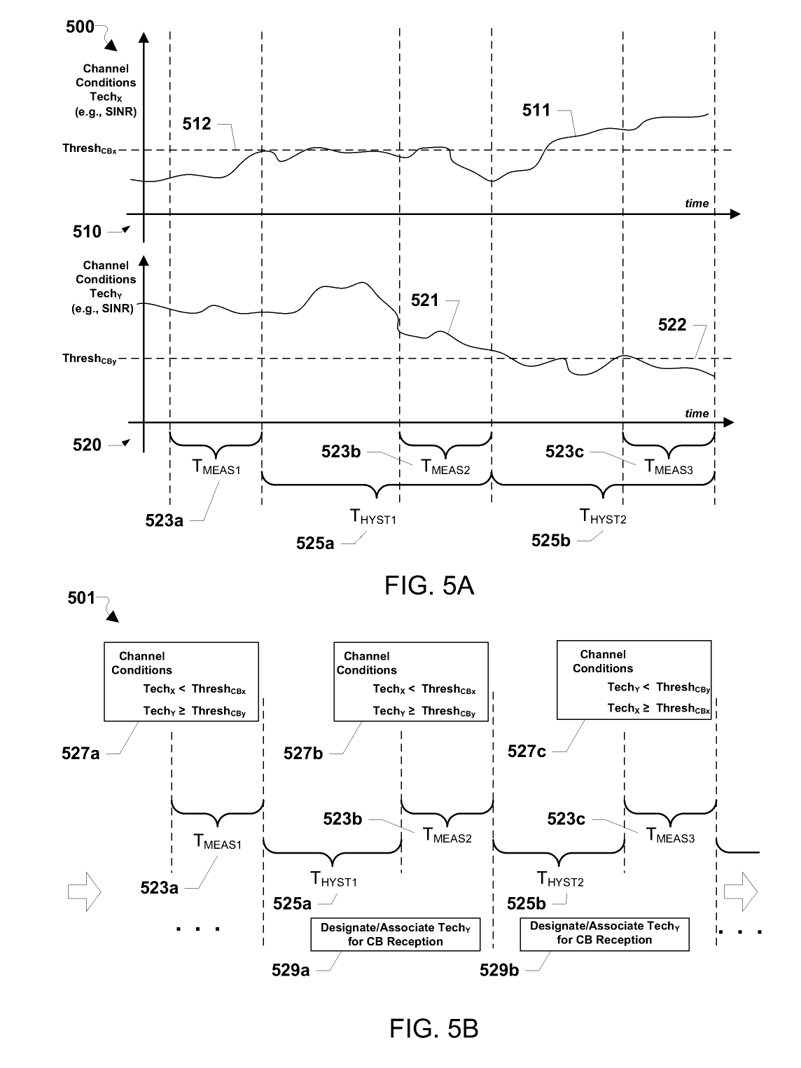

In accordance with various embodiments, reception of Cell Broadcasts may be managed to ensure successful reception while reducing unnecessary power consumption and redundancy. An illustration of channel conditions 500 is shown in FIG. 5A, illustrating measures of channel conditions during intervals. With reference to FIGS. 1A-5A, graph 510 shows a value, such as a channel condition value 511 of the channel conditions over time of a technology (e.g., Tech_{X}) associated with one of the subscriptions of a multi-SIM communication device. The channel condition value 511 may be a value indicative of the channel conditions, such as an SINR, or other value.

A threshold Thresh_{CBx} 512 for Tech_{X} may represent a minimum level of the channel condition value 511 that is sufficient to enable reliable reception of Cell Broadcasts. In some embodiments, the threshold Thresh_{CBx} 512 may be a common threshold that may be valid for use with both technologies Tech_{X} and Tech_{Y}. In some embodiments, the threshold or minimum level of the channel condition value 511 may be different for the channel conditions that enable reliable reception of Cell Broadcasts and for enable reliable reception of other signals or traffic. For example, the minimum level of the channel condition value 511 that is sufficient to enable reliable reception of Cell Broadcasts may be less than (or greater than) a level of a channel condition value that would be sufficient to support voice or data traffic for the same channel. The minimum level may further depend on the channel on which the Cell Broadcast is configured to be received.

The Cell Broadcast may be configured to be received on a dedicated Cell Broadcast Channel (CBCH), a Short Message Service (SMS) channel, a paging channel, etc. For example, in the event the Cell Broadcast is configured to be received on a dedicated Cell Broadcast Channel, the threshold or minimum level of the channel condition value 511 may only be relevant for reception of Cell Broadcasts.

Graph 520 shows a channel condition value 521 of the channel conditions over time of a technology (e.g., Tech_{Y}) associated with one of the other subscriptions of a multi-SIM communication device. The channel condition value 521 may be a value indicative of the channel conditions, such as a SINR, or other value.

A threshold Thresh_{CBy} 522 may also be established for Tech_{Y} representing a minimum level of the channel condition value 521 that is sufficient to enable reliable reception of the Cell Broadcast on Tech_{Y}. In some embodiments, the threshold Thresh_{CBy} 522 may be a common threshold that may be valid for use with both technologies Tech_{X} and Tech_{Y}. Since, due to their nature, actual Cell Broadcasts may not be generated frequently, the thresholds Thresh_{CBx} 512 and Thresh_{CBy} 522 may be stored from previous Cell Broadcast receptions. Alternatively or additionally, depending on the channel that is expected to be used for reception of the Cell Broadcast, periodic paging messages may be received. Such periodic paging messages may be used to determine the channel conditions sufficient to receive Cell Broadcasts, and thus establish the thresholds Thresh_{CBx} 512 and Thresh_{CBy} 522.

Alternatively or additionally, the thresholds Thresh_{CBx} 512 and Thresh_{CBy} 522 may be established based on paging messages, test sequences, or other transmissions, which may be performed periodically by the system (e.g., as may be required by rules or standards), or which may have been performed at other times by the Cell Broadcast system, the multi-SIM communication device and/or the infrastructure.

In various embodiments, the signal conditions for the technologies Tech_{X} and Tech_{Y} may be measured during a measurement interval T_{MEASi}, such as while the technology is active on the multi-SIM communication device, configured for Cell Broadcast reception, and other such conditions. Thus, for the channel conditions 500, the channel condition values 511 and 521 may be measured during measurement intervals, such as a T_{MEAS1} 523a, a T_{MEAS2} 523b, and a T_{MEAS3} 523c. To prevent rapid cycling due to rapid changes in the channel condition values 511 and 521, the measurement intervals T_{MEAS1} 523a, T_{MEAS2} 523b, and T_{MEAS3} 523c may be separated by hysteresis intervals T_{HYSTi}. Thus, the measurement intervals T_{MEAS1} 523a and T_{MEAS2} 523b may be separated by a hysteresis interval T_{HYST1} 525a, and the measurement intervals T_{MEAS2} 523b and T_{MEAS3} 523c may be separated by a hysteresis interval T_{HYST2} 525b and so on.

An example timeline 501 is illustrated in FIG. 5B. With reference to FIGS. 1A-5B, during each of the measurement intervals T_{MEAS1} 523a, T_{MEAS2} 523b, and T_{MEAS3} 523c, the channel conditions, as reflected in the channel condition values 511 and 521, may be measured for each technology Tech_{X} and Tech_{Y}. The channel condition values 511 and 521 may be averaged during the measurement intervals. Alternatively or additionally, a trend for the channel condition values 511 and 521 may be determined, such as whether the channel conditions are improving or degrading, or other operations may be performed to determine the channel condition values 511 and 521 or derivative values indicative of the channel conditions.

In block 527a, the processor of the multi-SIM communication device may determine the channel conditions relative to the thresholds and relative to each technology. For example, the processor may determine that the measured channel condition value 511 (or averages) for the channel conditions for Tech_{X} are less than the threshold Thresh_{CBx} 512 (e.g., Tech_{X}<Thresh_{CBx}) during the measurement interval T_{MEAS1} 523a. The processor may further determine that the measured channel condition value 521 (or averages) for the channel conditions for Tech_{Y} are greater than or equal to the threshold Thresh_{CBy} 522 (e.g., Tech_{Y}≧Thresh_{CBy}) during the measurement interval T_{MEAS1} 523a. In block 529a, based on the evaluated relative conditions in block 527a, the processor may designate, associate, assign, etc. the reception of Cell Broadcasts to Tech_{Y} during the hysteresis interval T_{HYST1} 525a.

Similarly, in block 527b, the processor may determine that the measured channel condition value 511 (or averages) for the channel conditions for Techₓ are less than the threshold Thresh_{CBx} 512 (e.g., Tech_{X} <Thresh_{CBx}) during the measurement interval T_{MEAS2} 523b. The processor may further determine that the measured channel condition value 521 (or averages) for the channel conditions for Tech_{Y} are greater than or equal to the threshold Thresh_{CBy} 522 (e.g., Tech_{Y}≧Thresh_{CBy}) during the measurement interval T_{MEAS2} 523b. Based on the evaluated relative conditions in block 527b, the processor may designate the reception of Cell Broadcasts to Tech_{Y} during the hysteresis interval T_{HYST2} 525b in block 529b.

In block 527c, the processor may determine that the measured channel condition value 521 (or averages) for the channel conditions for Tech_{Y} are less than the threshold Thresh_{CBy} 522 (e.g., Tech_{Y}<Thresh_{CBy}) during the measurement interval T_{MEAS3} 523c. The processor may further determine that the measured channel condition value 511 (or averages) for the channel conditions for Tech_{X} are greater than or equal to the threshold Thresh_{CBx} 512 (e.g., Tech_{X} >Thresh_{CBx}) during the measurement interval T_{MEAS3} 523c. Following this, based on the evaluated relative conditions in block 527c, the processor may designate the reception of Cell Broadcasts to Tech_{X} during a subsequent hysteresis interval (e.g., T_{HYST3}, not shown).

As discussed, although channel condition thresholds may be specified for each of the technologies Tech_{X} and Tech_{Y}, in some embodiments the channel condition thresholds may be the same (Thresh_{CBy}=Thresh_{CBx}). Thus, in various embodiments there may be a single channel condition threshold against which all technologies are compared. Alternatively, there may be a different channel condition threshold for each technology. Still further, while the channel condition thresholds may be effectively the same, the parameter compared to the threshold (e.g., RSSI, SINR, etc.) may differ depending upon the technology.

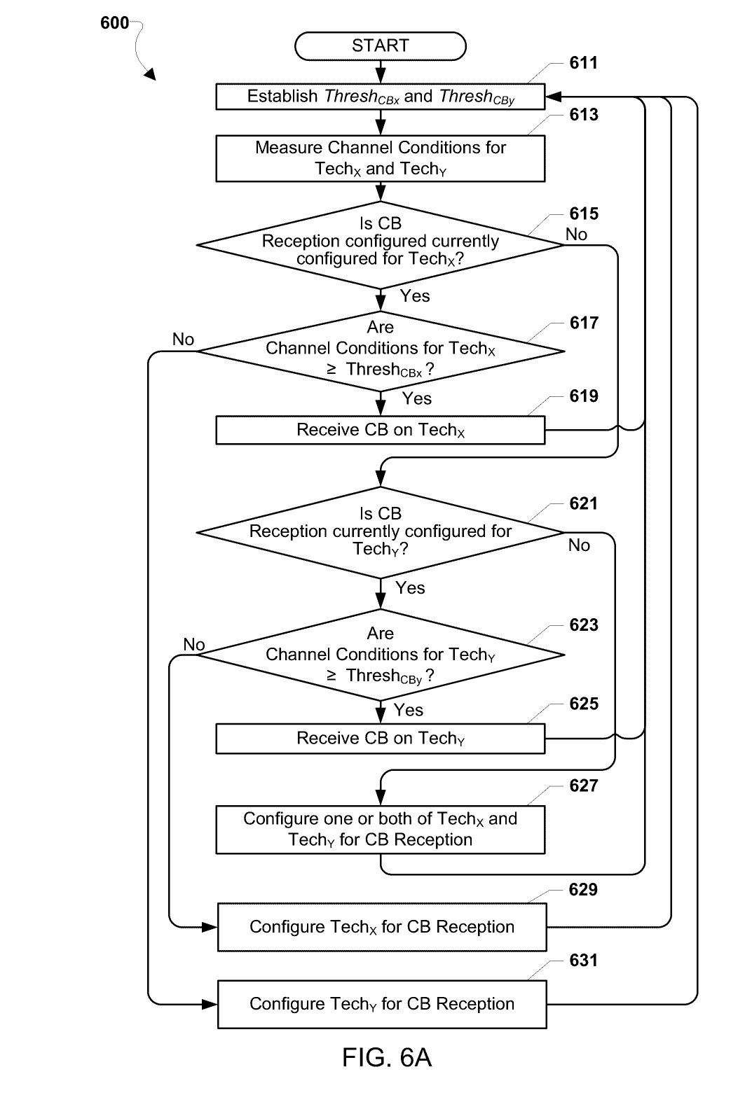

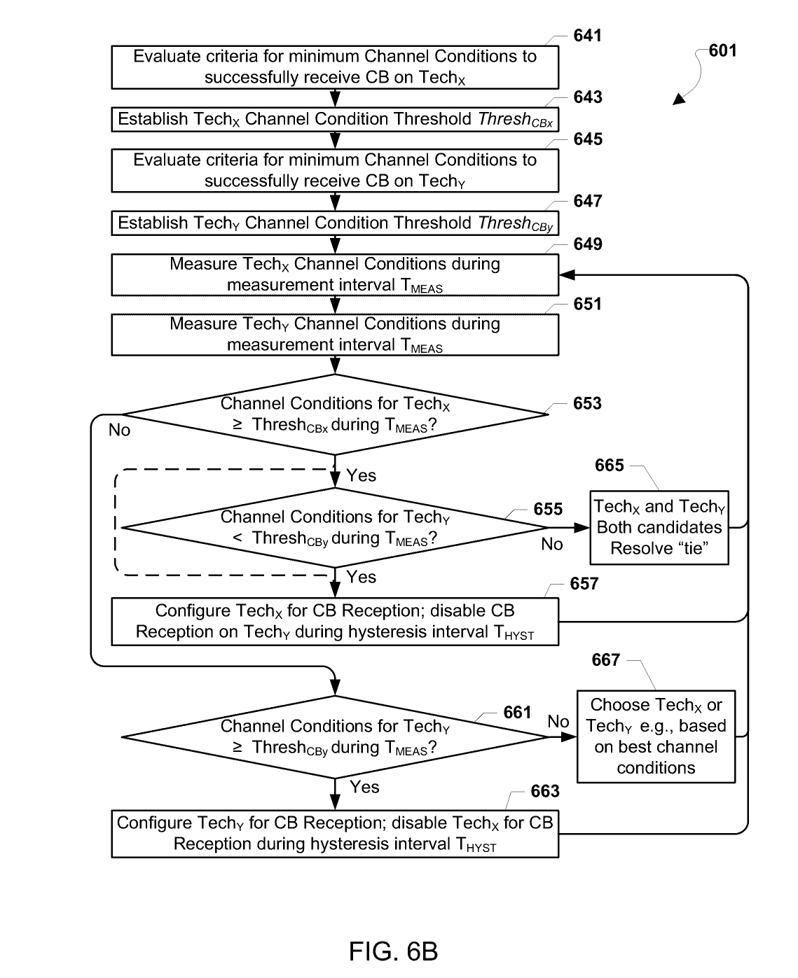

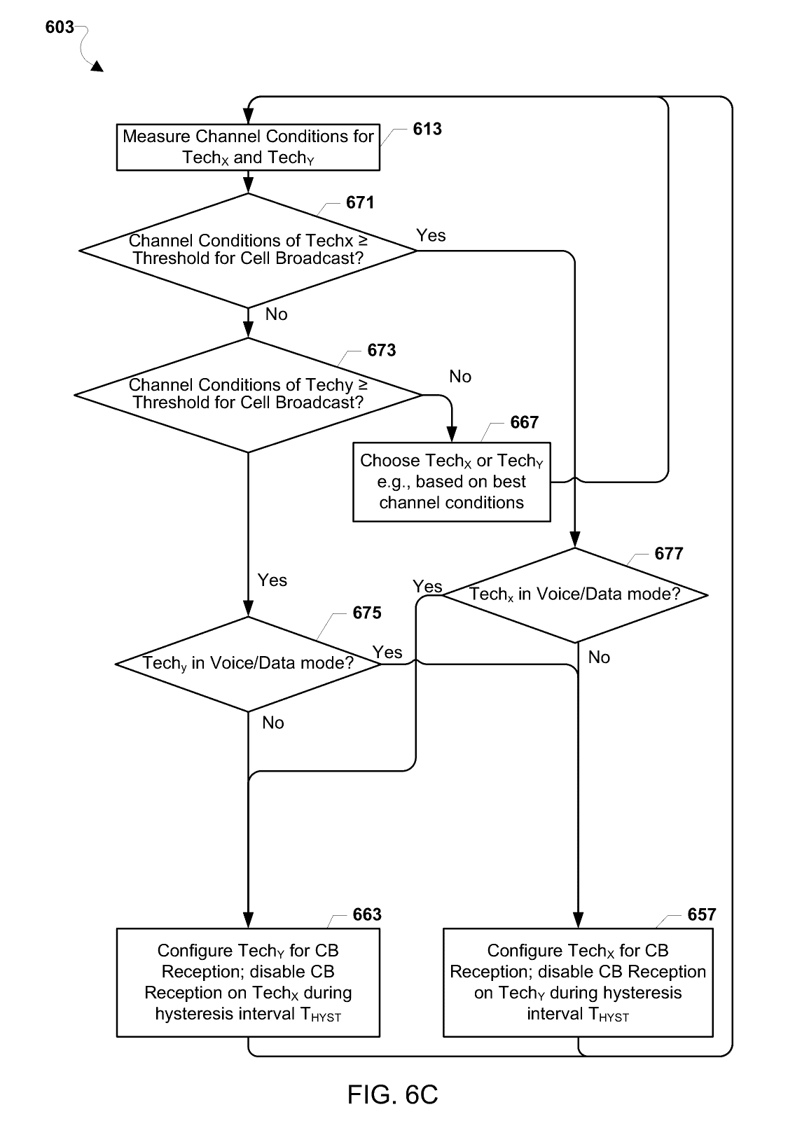

A method 600 for performing operations for assigning the reception of Cell Broadcasts according to various embodiments is illustrated in FIG. 6A. With reference to FIGS. 1A-6A, the method 600 may be implemented on a multi-SIM communication device processor (e.g., the processor 206 or the baseband modem processor 216) configured with processor-executable instructions to perform the operations of the method.

In block 611, the processor may establish thresholds for each of the technologies on which Cell Broadcasts may be received. For example, the processor may establish Thresh_{CBx} and Thresh_{CBy} for each of the technologies Tech_{X} and Tech_{Y} on which Cell Broadcasts may be received. Establishing the thresholds may be made by measuring, testing, or may be established as an accepted threshold level from a previous Cell Broadcast reception, or other suitable method. Alternatively or additionally, establishing the thresholds may be made by retrieving the threshold value from a memory on the multi-SIM communication device, which may include a memory of the SIM itself or of the multi-SIM communication device (e.g., 214).

In block 613, the processor may measure the channel conditions for each of the technologies Tech_{X} and Tech_{Y} on which Cell Broadcasts will be received. For example, the processor may measure the signal-plus-interference-to-noise ratio (SINR), received signal strength (RSSI), or similar level indicative of channel conditions.

In determination block 615, the processor may determine whether Tech_{X} is currently configured for Cell Broadcast reception.

In response to determining that the Tech_{X} is currently configured for Cell Broadcast reception (i.e., determination block 615=“Yes”), the processor may determine whether the channel conditions for Tech_{X} are greater than or equal to the Cell Broadcast reception threshold Thresh_{CBx} in determination block 617. In response to determining that the channel conditions for Tech_{X} are greater than or equal to the Cell Broadcast reception threshold Thresh_{CBx} (i.e., determination block 617=“Yes”), the processor may configure Tech_{X} to receive Cell Broadcasts in block 619. In response to determining that the channel conditions for Tech_{X} are not greater than or equal to the Cell Broadcast reception threshold Thresh_{CBx} (i.e., determination block 617=“No”), the processor may configure Tech_{Y} to receive Cell Broadcasts in block 631.

In response to determining that the Tech_{X} is not currently configured for Cell Broadcast reception (i.e., determination block 615=“No”), the processor may determine whether Cell Broadcast reception is currently configured for Tech_{Y} in determination block 621. In response to determining that the Cell Broadcast reception is not currently configured for Tech_{Y} (i.e., determination block 621=“No”), the processor may configure one or both of TechX and TechY for Cell Broadcast reception in block 627.

In response to determining that the Cell Broadcast reception is currently configured for Tech_{Y} (i.e., determination block 621=“Yes”), the processor may determine whether the channel conditions for Tech_{Y} are greater than or equal to the Cell Broadcast reception threshold Thresh_{CBy} in determination block 623. In response to determining that the channel conditions for Tech_{Y} are greater than or equal to the Cell Broadcast reception threshold Thresh_{CBy} (i.e., determination block 623=“Yes”), the processor may receive Cell Broadcasts on Tech_{Y} in block 625. The processor may further disable reception of Cell Broadcasts on Tech_{X}. In response to determining that the channel conditions for Tech_{Y} are not greater than or equal to the Cell Broadcast reception threshold Thresh_{CBy} (i.e., determination block 623=“No”), the processor may configure the multi-SIM communication device for reception of the Cell Broadcast on Tech_{X} in block 629. The processor may further disable reception of Cell Broadcasts on Tech_{Y}.

A method 601 for performing operations for assigning the reception of Cell Broadcasts according to various embodiments is illustrated in FIG. 6B. With reference to FIGS. 1A-6B, the method 601 may be implemented on a multi-SIM communication device processor (e.g., the processor 206 or the baseband modem processor 216) configured with processor-executable instructions to perform the operations of the method.

In block 641, the processor may evaluate criteria for the minimum channel conditions necessary to successfully receive a Cell Broadcast on technology Tech_{X}. For example, the processor may refer to previous reception successes for various paging and/or traffic channels of Tech_{X} on which the Cell Broadcast or portions of the Cell Broadcast is expected to be received. The processor may evaluate the successful reception of other traffic or pages on the Tech_{X} channels in order to determine the minimum criteria for successful Cell Broadcast reception on technology Tech_{X}. In block 643, the processor may establish the Tech_{X} channel condition threshold Thresh_{CBx}, such as based on the evaluation and criteria from block 641.

In block 645, the processor may evaluate criteria for the minimum channel conditions necessary to successfully receive Cell Broadcasts on technology Tech_{Y}. For example the processor may refer to previous reception successes for various paging and/or traffic channels of Tech_{Y} on which the Cell Broadcast or portions of the Cell Broadcast is expected to be received. The processor may evaluate the successful reception of other traffic or pages on the Tech_{Y} channels in order to determine the minimum criteria for successful Cell Broadcast reception on technology Tech_{Y}. In block 647, the processor may establish the Tech_{Y} channel condition threshold Thresh_{CBy}, such as based on the evaluation and criteria from block 645.

In block 649, the processor may measure the channel conditions of Tech_{X} during a measurement interval T_{MEAS}. In block 651, the processor may measure the channel conditions of Tech_{Y} during the measurement interval T_{MEAS}. As described, the processor may measure values indicative of the link quality, channel conditions, etc. such as SINR, RSSI, etc.

In determination block 653, the processor may determine whether the measured channel conditions for Tech_{X} are greater than or equal to the Tech_{X} Cell Broadcast reception threshold Thresh_{CBx}.

In response to determining that the measured channel conditions for Tech_{X} are greater than or equal to the Tech_{X} Cell Broadcast reception threshold Thresh_{CBx} (i.e., determination block 653=“Yes”), the processor may determine whether the measured channel conditions for Tech_{Y} are less than the Tech_{Y} Cell Broadcast reception threshold Thresh_{CBy} in determination block 655. Alternatively, the processor may configure Tech_{X} for Cell Broadcast reception and disable Cell Broadcast reception on Tech_{Y} during a hysteresis interval T_{HYST} in block 657 (e.g., bypassing determination block 655).

In response to determining that the measured channel conditions for Tech_{Y} are less than the Tech_{Y} Cell Broadcast reception threshold Thresh_{CBy} (i.e., determination block 655=“Yes”), the processor may configure Tech_{X} for Cell Broadcast reception and disable Cell Broadcast reception on Tech_{Y} during a hysteresis interval T_{RYST} in block 657, and return to block 649 to make channel condition measurements for the next measurement interval T_{MEAS}.

In response to determining that the measured channel conditions for Tech_{Y} are not less than the Tech_{Y} Cell Broadcast reception threshold Thresh_{CBy} (i.e., determination block 655=“No”), the processor may implement a process to select between Tech_{X} and Tech_{Y} in block 665 because the channel conditions of both Tech_{X} and Tech_{Y} are above their respective Cell Broadcast reception thresholds Thresh_{CBx} and Thresh_{CBy}. Thus, either technology could be used to receive Cell Broadcasts. When this condition is detected, the processor may resolve the “tie” by any of several methods. In some embodiments, one of Tech_{X} and Tech_{Y} may be predesignated as the preferred or default technology for receiving Cell Broadcasts. In some embodiments, the processor may select the technology that exceeds the corresponding threshold by the greatest amount. In some embodiments, the processor may determine the technology for receiving Cell Broadcasts that is least likely to be involved in a voice or data call, such as based on usage history, user preferences, etc. In some embodiments, the processor may make a random selection of one technology for receiving Cell Broadcasts. Any other suitable method for resolving the tie may also be implemented.

In response to determining that the measured channel conditions for Tech_{X} are not greater than or equal to the Tech_{X} Cell Broadcast reception threshold Thresh_{CBx} (i.e., determination block 653=“No”), the processor may determine whether the measured channel conditions for Tech_{Y} are greater than or equal to the Tech_{Y} Cell Broadcast reception threshold Thresh_{CBy} in determination block 661.

In response to determining that the measured channel conditions for Tech_{Y} are not greater than or equal to the Tech_{Y} Cell Broadcast reception threshold Thresh_{CBy} (i.e., determination block 661=“No”), the processor may implement a process to select between Tech_{X} and Tech_{Y} in block 667. This process may be needed because neither of the channel conditions of Tech_{X} and Tech_{Y} are above their respective Cell Broadcast reception thresholds Thresh_{CBx} and Thresh_{CBy}. Thus, neither technology would ordinarily be selected to receive Cell Broadcasts. When this condition is detected (i.e., determination block 661=“No”), the processor may select one of the technologies by any of several methods. In some embodiments, one of Tech_{X} and Tech_{Y} may be predesignated as the preferred or default technology for receiving Cell Broadcasts either specifically when neither technology is above their respective Cell Broadcast reception thresholds Thresh_{CBx} and Thresh_{CBy}. In some embodiments, the processor may select the technology that is closest to the corresponding threshold (e.g., the technology with the “best” channel conditions for receiving Cell Broadcast). In some embodiments, the processor may designate the technology for receiving Cell Broadcasts that is least likely to be involved in a voice or data call, such as based on usage history, user preferences, etc. In some embodiments, the processor may make a random selection of one technology for receiving Cell Broadcasts. Any other suitable method for selecting a technology for receiving broadcasts when both technologies are sub-threshold may also be implemented. The processor may return to making channel condition measurements for the next measurement interval T_{MEAS} in block 649.

In response to determining that the measured channel conditions for Tech_{Y} are greater than or equal to the Tech_{Y} Cell Broadcast reception threshold Thresh_{CBy} (i.e., determination block 661=“Yes”), the processor may configure Tech_{Y} for Cell Broadcast reception and disable Cell Broadcast reception on Tech_{X} during a hysteresis interval T_{RYST} in block 663, and return to block 649 to make channel condition measurements for the next measurement interval T_{MEAS}.

A method 603 for performing operations for assigning the reception of Cell Broadcasts according to some embodiments is illustrated in FIG. 6C. With reference to FIGS. 1A-6C, the method 603 may be implemented on a multi-SIM communication device processor (e.g., the processor 206 or the baseband modem processor 216) configured with processor-executable instructions to perform the operations of the method.

In block 613, the processor may measure channel conditions as described regarding the method 600.

In determination block 671, the processor may determine whether measured channel conditions for Tech_{X} are greater than or equal to a threshold value. As described, the threshold may be a common threshold (e.g., SINR) or may be a technology specific threshold (e.g., RSSI, SINR, etc.).

In response to determining that measured channel conditions for Tech_{X} are not greater than or equal to a threshold value (i.e., determination block 671=“No”), the processor may determine whether measured channel conditions for Tech_{Y} are greater than or equal to the threshold value in determination block 673. In response to determining that measured channel conditions for Tech_{Y} are not greater than or equal to the threshold value (i.e., determination block 673=“No”), the processor may implement a process to select between Tech_{X} and Tech_{Y} in block 667 as described.

In response to determining that the measured channel conditions for Tech_{Y} are greater than or equal to the threshold value (i.e., determination block 673=“Yes”), the processor may determine whether Tech_{Y} is in a Voice/Data call mode in determination block 675. In response to determining that Tech_{Y} is not in a Voice/Data call mode (i.e., determination block 675=“No”), the processor may associate or designate Tech_{Y} (and disable Cell Broadcast reception on Tech_{X}) for Cell Broadcast reception in block 663 as described (FIG. 6B). In response to determining that Tech_{Y} is in a Voice/Data call mode (i.e., determination block 675=“Yes”), the processor may associate or designate Tech_{X} for Cell Broadcast reception (and disable Cell Broadcast reception on Tech_{Y}) in block 657 as described (FIG. 6B).

In response to determining that measured channel conditions for Tech_{X} are greater than or equal to a threshold value (i.e., determination block 671=“Yes”), the processor may determine whether Tech_{X} is in a Voice/Data call mode in determination block 677. In response to determining that Tech_{X} is not in a Voice/Data call mode (i.e., determination block 677=“No”), the processor may associate or designate Tech_{X} (and disable Cell Broadcast reception on Tech_{Y}) for Cell Broadcast reception in block 657 as described (FIG. 6B). In response to determining that Tech_{X} is in a Voice/Data call mode (i.e., determination block 677=“Yes”), the processor may associate or designate Tech_{Y} for Cell Broadcast reception (and disable Cell Broadcast reception on Tech_{X}) in block 663 as described (FIG. 6B).

Some technologies may allow Cell Broadcast reception during a data call. Thus, in some embodiments, the operations may be modified such that a given technology (e.g., Tech_{X}, Tech_{Y}) may be configured to receive a Cell Broadcast as long as a voice call is not in progress and threshold conditions are satisfied. The ability to receive Cell Broadcasts during data calls may depend on the radio access technology and/or the service provider. Thus, in some embodiments, as part of the operations of determining whether a technology is in a Voice/Data call mode (e.g., in determination blocks 675 and 677) may include determining whether the technology is in a Data call mode and whether Cell Broadcast reception during a data call is permitted for the technology. If the technology/service provider permits Cell Broadcast reception during data calls, the technology may be configured for Cell Broadcast reception during the data call. For example, the technology Tech_{Y} may be configured for Cell Broadcast reception in block 663 in response to determining that technology Tech_{Y} is not in a voice call mode (i.e., determination block 675=“No”) because Tech_{Y} is in a data call mode. Similarly, technology Tech_{X} may be configured for Cell Broadcast reception in block 657 in response to determining that technology Tech_{X} is not in a voice call mode (i.e., determination block 677=“No”) because Tech_{X} is in a data call mode. However, because at least some technologies do not allow Cell Broadcast reception during data calls, a full description of embodiments in which Cell Broadcasts can be received during data call modes (but not voice call modes) is omitted for simplicity and generality.

The operations of the method 603 may be performed in a loop by periodically measuring channel conditions for both technologies in block 613 and proceeding as described.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the method 600 may be substituted for or combined with one or more operations of the method 601, the method 603, and so on.

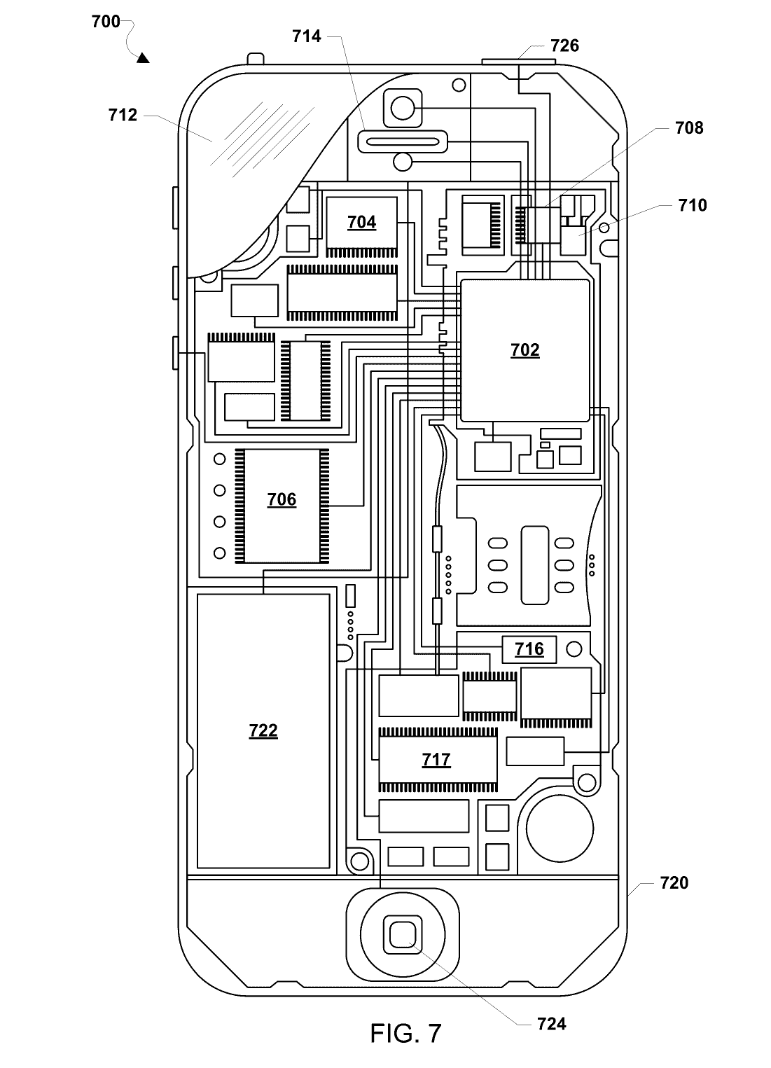

Various embodiments may be implemented in any of a variety of multi-SIM communication devices, an example of which (e.g., multi-SIM communication device 700) is illustrated in FIG. 7. With reference to FIGS. 1A-7, the multi-SIM communication device 700 may be similar to the multi-SIM communication devices 110, 120, 200, 250 as described. As such, the multi-SIM communication device 700 may implement the methods 600 and 601 as described, or may perform other operations according to various embodiments.

The multi-SIM communication device 700 may include a processor 702 coupled to a touchscreen controller 704 and an internal memory 706. The processor 702 may be one or more multi-core integrated circuits designated for general or specific processing tasks. The internal memory 706 may be volatile or non-volatile memory, and may also be secure and/or encrypted memory, or unsecure and/or unencrypted memory, or any combination thereof. The touchscreen controller 704 and the processor 702 may also be coupled to a touchscreen panel 712, such as a resistive-sensing touchscreen, capacitive-sensing touchscreen, infrared sensing touchscreen, etc. Additionally, the display of the multi-SIM communication device 700 need not have touch screen capability.

The multi-SIM communication device 700 may have a cellular network transceiver 708 coupled to the processor 702 and to an antenna 710 and configured for sending and receiving cellular communications. The transceiver 708 and the antenna 710 may be used to implement methods of various embodiments. The multi-SIM communication device 700 may include one or more SIM cards 716 coupled to the transceiver 708 and/or the processor 702 and may be configured as described. The multi-SIM communication device 700 may include a cellular network wireless modem chip 717 that enables communication via a cellular network and is coupled to the processor.

The multi-SIM communication device 700 may also include speakers 714 for providing audio outputs. The multi-SIM communication device 700 may also include a housing 720, constructed of a plastic, metal, or a combination of materials, for containing all or some of the components discussed herein. The multi-SIM communication device 700 may include a power source 722 coupled to the processor 702, such as a disposable or rechargeable battery. The rechargeable battery may also be coupled to the peripheral device connection port to receive a charging current from a source external to the multi-SIM communication device 700. The multi-SIM communication device 700 may also include a physical button 724 for receiving user inputs. The multi-SIM communication device 700 may also include a power button 726 for turning the multi-SIM communication device 700 on and off.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present embodiments.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configurations. Alternatively, some operations or methods may be performed by circuitry that is specific to a given function.

In one or more exemplary aspects, the functions described may be implemented in hardware, software, firmware, or any combination thereof If implemented in software, the functions may be stored as one or more instructions or code on a non-transitory computer-readable storage medium or non-transitory processor-readable storage medium. The operations of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the described media are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to some embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method implemented on a mobile communication device supporting a first subscription of a first radio access technology and a second subscription of a second radio access technology for managing reception of cell broadcasts, comprising:
measuring a channel condition for each of the first radio access technology and the second radio access technology during a measurement period;
determining whether the measured channel condition of the first radio access technology is greater than or equal to a first threshold for receiving cell broadcasts;
determining whether the measured channel condition of the second radio access technology is greater than or equal to a second threshold for receiving cell broadcasts in response to determining that the measured channel condition of the first radio access technology is less than the first threshold for receiving cell broadcasts; and
designating the second radio access technology to receive cell broadcasts during an interval and disabling cell broadcast reception on the first radio access technology during the interval in response to determining that the measured channel condition of the second radio access technology is greater than or equal to the second threshold for receiving cell broadcasts.

2. The method of claim 1, further comprising:
determining whether the mobile communication device is in a Voice/Data call mode using the second radio access technology,
wherein designating the second radio access technology to receive cell broadcasts during the interval and disabling cell broadcast reception on the first radio access technology during the interval is performed in response to determining that the measured channel condition of the second radio access technology is greater than or equal to the second threshold for receiving cell broadcasts and that the mobile communication device is not in a Voice/Data call mode using the second radio access technology.

3. The method of claim 2, further comprising:
designating the first radio access technology to receive cell broadcasts during the interval and disabling cell broadcast reception on the second radio access technology during the interval in response to determining that the mobile communication device is in a Voice/Data call mode using the second radio access technology.

4. The method of claim 3, further comprising remeasuring channel conditions for the first and second radio access technologies after the interval and redesignating one of the first and second radio access technologies to receive cell broadcasts based on the remeasured channel conditions.

5. The method of claim 1, further comprising:
designating the first radio access technology to receive cell broadcasts during the interval and disabling cell broadcast reception on the second radio access technology during the interval in response to determining that the measured channel condition of the first radio access technology is greater than or equal to the first threshold for receiving cell broadcasts.

6. The method of claim 5, further comprising:
determining whether the mobile communication device is in a Voice/Data call mode using the first radio access technology,
wherein designating the first radio access technology to receive cell broadcasts during the interval T and disabling cell broadcast reception on the second radio access technology during the interval is performed in response to determining that the measured channel condition of the first radio access technology is greater than or equal to the first threshold for receiving cell broadcasts and that the mobile communication device is not in a Voice/Data call mode using the first radio access technology.

7. The method of claim 1, further comprising establishing the first threshold for receiving cell broadcasts by measuring a signal received on a channel associated with receiving the cell broadcasts.

8. The method of claim 1, wherein the first threshold for receiving cell broadcasts on the first radio access technology is different from the second threshold for receiving cell broadcasts on the second radio access technology.

9. The method of claim 1, wherein the first threshold for receiving cell broadcasts on the first radio access technology is the same as the second threshold for receiving cell broadcasts on the second radio access technology.

10. The method of claim 1, further comprising:
selecting one of the first radio access technology and the second radio access technology to receive cell broadcasts in response to determining that measured channel conditions of both the first radio access technology and the second radio access technology are not greater than or equal to first threshold and the second threshold, respectively; and
designating the selected one of the first radio access technology and the second radio access technology to receive cell broadcasts.

11. A multi-subscriber identity module (SIM) communication device, comprising:
a radio-frequency (RF) resource;
a memory; and
a processor coupled to the RF resource, and the memory, the processor configured to connect to a first SIM for a first subscription to a first radio access technology and a second SIM for a second subscription to a second radio access technology, and the processor configured with processor-executable instructions to:
measure a channel condition for each of the first radio access technology and the second radio access technology during a measurement period;
determine whether the measured channel condition of the first radio access technology is greater than or equal to a first threshold for receiving cell broadcasts;
determine whether the measured channel condition of the second radio access technology is greater than or equal to a second threshold for receiving cell broadcasts in response to determining that the measured channel condition of the first radio access technology is less than the first threshold for receiving cell broadcasts; and
designate the second radio access technology to receive cell broadcasts during an interval and disable cell broadcast reception on the first radio access technology during the interval in response to determining that the measured channel condition of the second radio access technology is greater than or equal to the second threshold for receiving cell broadcasts.

12. The multi-SIM communication device of claim 11, wherein the processor is further configured with processor-executable instructions to
determine whether the multi-SIM communication device is in a Voice/Data call mode using the second radio access technology,
wherein designating the second radio access technology to receive cell broadcasts during an interval and disabling cell broadcast reception on the first radio access technology during the interval is performed in response to determining that the measured channel condition of the second radio access technology is greater than or equal to the second threshold for receiving cell broadcasts and that the multi-SIM communication device is not in a Voice/Data call mode using the second radio access technology.

13. The multi-SIM communication device of claim 12, wherein the processor is further configured with processor-executable instructions to
designate the first radio access technology to receive cell broadcasts during the interval and disable cell broadcast reception on the second radio access technology during the interval in response to determining that the multi-SIM communication device is in a Voice/Data call mode using the second radio access technology.

14. The multi-SIM communication device of claim 13, wherein the processor is further configured with processor-executable instructions to remeasure channel conditions for the first and second radio access technologies after the interval and redesignating one of the first and second radio access technologies to receive cell broadcasts based on the remeasured channel conditions.

15. The multi-SIM communication device of claim 11, wherein the processor is further configured with processor-executable instructions to:
designate the first radio access technology to receive cell broadcasts during the interval and disabling cell broadcast reception on the second radio access technology during the interval in response to determining that the measured channel condition of the first radio access technology is greater than or equal to the first threshold for receiving cell broadcasts.

16. The multi-SIM communication device of claim 15, wherein the processor is further configured with processor-executable instructions to:
determine whether the multi-SIM communication device is in a Voice/Data call mode using the first radio access technology,
wherein designating the first radio access technology to receive cell broadcasts during an interval and disabling cell broadcast reception on the second radio access technology during the interval is performed in response to determining that the measured channel condition of the first radio access technology is greater than or equal to the first threshold for receiving cell broadcasts and that the multi-SIM communication device is not in a Voice/Data call mode using the first radio access technology.

17. The multi-SIM communication device of claim 11, wherein the processor is further configured with processor-executable instructions to establish the first and second thresholds for receiving cell broadcasts by measuring a signal received on a channel associated with receiving the cell broadcasts.

18. The multi-SIM communication device of claim 11, wherein the first threshold for receiving cell broadcasts on the first radio access technology is different from the second threshold for receiving cell broadcasts on the second radio access technology.

19. The multi-SIM communication device of claim 11, wherein the first threshold for receiving cell broadcasts on the first radio access technology is the same as the second threshold for receiving cell broadcasts on the second radio access technology.

20. The multi-SIM communication device of claim 15, wherein the processor is further configured with processor-executable instructions to:
select one of the first radio access technology and the second radio access technology to receive cell broadcasts in response to determining that measured channel conditions of both the first radio access technology and the second radio access technology are not greater than or equal to first threshold and the second threshold, respectively; and
designate the selected one of the first radio access technology and the second radio access technology to receive cell broadcasts.

21. A multi-subscriber identity module (SIM) communication device, comprising:
means for measuring a channel condition for each of a first radio access technology and a second radio access technology during a measurement period;
means for determining whether the measured channel condition of the first radio access technology is greater than or equal to a first threshold for receiving cell broadcasts;
means for determining whether the measured channel condition of the second radio access technology is greater than or equal to a second threshold for receiving cell broadcasts in response to determining that the measured channel condition of the first radio access technology is less than the first threshold for receiving cell broadcasts; and
means for designating the second radio access technology to receive cell broadcasts during an interval and disabling cell broadcast reception on the first radio access technology during the interval in response to determining that the measured channel condition of the second radio access technology is greater than or equal to the second threshold for receiving cell broadcasts.

22. A non-transitory processor-readable storage medium having stored thereon processor-executable instructions configured to cause a processor of a multi-subscriber identity module (SIM) communication device to perform operations comprising:
measuring a channel condition for each of a first radio access technology and a second radio access technology during a measurement period;
determining whether the measured channel condition of the first radio access technology is greater than or equal to a first threshold for receiving cell broadcasts;
determining whether the measured channel condition of the second radio access technology is greater than or equal to a second threshold for receiving cell broadcasts in response to determining that the measured channel condition of the first radio access technology is less than the first threshold for receiving cell broadcasts; and
designating the second radio access technology to receive cell broadcasts during an interval and disabling cell broadcast reception on the first radio access technology during the interval in response to determining that the measured channel condition of the second radio access technology is greater than or equal to the second threshold for receiving cell broadcasts.

23. The non-transitory processor-readable storage medium of claim 22, wherein the stored processor-executable instructions are configured to cause the processor of the multi-SIM communication device to perform operations further comprising determining whether the multi-SIM communication device is in a Voice/Data call mode using the second radio access technology,
wherein the stored processor-executable instructions are configured to cause the processor of the multi-SIM communication device to perform operations such that designating the second radio access technology to receive cell broadcasts during an interval and disabling cell broadcast reception on the first radio access technology during the interval is performed in response to determining that the measured channel condition of the second radio access technology is greater than or equal to the second threshold for receiving cell broadcasts and that the multi-SIM communication device is not in a Voice/Data call mode using the second radio access technology.

24. The non-transitory processor-readable storage medium of claim 23, wherein the stored processor-executable instructions are configured to cause the processor of the multi-SIM communication device to perform operations further comprising:
designating the first radio access technology to receive cell broadcasts during the interval and disabling cell broadcast reception on the second radio access technology during the interval in response to determining that the multi-SIM communication device is in a Voice/Data call mode using the second radio access technology.

25. The non-transitory processor-readable storage medium of claim 24, wherein the stored processor-executable instructions are configured to cause the processor of the multi-SIM communication device to perform operations further comprising remeasuring channel conditions for the first and second radio access technologies.

26. The non-transitory processor-readable storage medium of claim 22, wherein the stored processor-executable instructions are configured to cause the processor of the multi-SIM communication device to perform operations further comprising:
designating the first radio access technology to receive cell broadcasts during the interval and disabling cell broadcast reception on the second radio access technology during the interval in response to determining that the measured channel condition of the first radio access technology is greater than or equal to the first threshold for receiving cell broadcasts.

27. The non-transitory processor-readable storage medium of claim 26, wherein the stored processor-executable instructions are configured to cause the processor of the multi-SIM communication device to perform operations further comprising determining whether the multi-SIM communication device is in a Voice/Data call mode using the first radio access technology,
wherein designating the first radio access technology to receive cell broadcasts during an interval and disabling cell broadcast reception on the second radio access technology during the interval is performed in response to determining that the measured channel condition of the first radio access technology is greater than or equal to the first threshold for receiving cell broadcasts and that the multi-SIM communication device is not in a Voice/Data call mode using the first radio access technology.

28. The non-transitory processor-readable storage medium of claim 22, wherein the stored processor-executable instructions are configured to cause the processor of the multi-SIM communication device to perform operations further comprising establishing the first and second thresholds for receiving cell broadcasts by measuring a signal received on a channel associated with receiving the cell broadcasts.

29. The non-transitory processor-readable storage medium of claim 22, wherein the first threshold for receiving cell broadcasts on the first radio access technology is different from the second threshold for receiving cell broadcasts on the second radio access technology.

30. The non-transitory processor-readable storage medium of claim 22, wherein the first threshold for receiving cell broadcasts on the first radio access technology is the same as the second threshold for receiving cell broadcasts on the second radio access technology.
